(19) United States
(12) Patent Application Publication
(10) Pub. No.: US 2017/0051821 A1
(43) Pub. Date: Feb. 23, 2017

(54) TRANSMISSION PAN WITH INTEGRATED HEAT EXCHANGER

(71) Applicant: GM Global Technology Operations LLC, Detroit, MI (US)

(72) Inventors: Michael G. Long, Troy, MI (US); David Robert Ehlen, Rochester Hills, MI (US); Damion Creffield, Manchester, MI (US); Eric J. Peers, Marine City, MI (US)

(21) Appl. No.: 14/828,060

(22) Filed: Aug. 17, 2015

(51) Int. Cl. F16H 57/04; F01M 5/00

(52) U.S. Cl. CPC F16H 57/0412; F16H 57/0452; F01M 5/005; F01P 2060/045

(57) ABSTRACT

A transmission pan with integrated heat exchanger for an automobile vehicle includes a transmission pan. A heat exchanger is positioned entirely within transmission pan and is fixed to a bottom inner surface of the transmission pan. The heat exchanger includes a substantially flat surface. The surface includes a first flow port defining a transmission fluid inlet port, and a second flow port defining a transmission fluid outlet port. A cooling header assembly has an inlet header and an outlet header, each fixed to and sealed at an entrance through a wall of the heat exchanger. The inlet header and the outlet header also each penetrate an outer wall of the transmission pan and are each fixed to and sealed where the penetrations of the inlet header and the outlet header contact the outer wall.

### FIELD

The present disclosure relates to a fluid collection pan for motor vehicle transmissions having an integrated fluid heat exchanger within the pan.

### BACKGROUND

The statements in this section merely provide background information related to the present disclosure and may or may not constitute prior art.

Automobile vehicle automatic transmissions have low sump areas used to collect fluid such as transmission fluid which is circulated throughout the transmission and used to lubricate and cool the transmission. It is common that transmission fluid is withdrawn from the transmission and routed forward to a separate heat exchanger incorporated in an engine cooling radiator, so the transmission fluid can be either pre-heated or cooled as necessary. Pre-heating cold or ambient temperature transmission fluid has been identified to increase the fuel economy of the engine particularly during engine start conditions. Once the transmission fluid has been heated during vehicle operation, it is important to cool the fluid to mitigate degradation of its lubrication and operating properties. Tubing and connections required to provide flow to and return from the heat exchanger/radiator are expensive to provide and install, create separate maintenance issues due to damage from environmental conditions such as road debris, and magnify the number of locations where fluid leaks can occur. Adding a local externally mounted heat exchanger to the transmission pan to provide cooling or heating of the transmission fluid may result in undesirable damage to the heat exchanger due to the low ground level clearance position of the pan and the susceptibility of heat exchanger components and tubing to exposure to environmental conditions, including to thermal loss. The heat exchanger size may also have to be increased if the heat exchanger is externally mounted to account for ambient thermal losses.

Accordingly, there is room in the art for a transmission pan adapted to receive a heat exchanger for pre-heating and cooling a transmission fluid.

### SUMMARY

The present invention provides an example of a transmission pan with an integrated heat exchanger for a motor vehicle having an assembly including a transmission pan and a heat exchanger. The heat exchanger is positioned entirely within the transmission pan.

In one example of the transmission pan with integrated heat exchanger for a motor vehicle of the present disclosure, the heat exchanger includes a substantially flat surface, and a rectangular shaped body is adapted to minimize a depth “A” of the transmission pan required to incorporate a height “B” of the heat exchanger.

In yet another example of the transmission pan with integrated heat exchanger for a motor vehicle of the present disclosure, the surface includes a first flow port defining a transmission fluid inlet port, and a second flow port defining a transmission fluid outlet port.

In yet another example of the transmission pan with integrated heat exchanger for a motor vehicle of the present disclosure, the heat exchanger further includes a cooling header assembly having: an inlet header and an outlet header, each fixed to and sealed at an entrance through a wall of the heat exchanger; and the inlet header and the outlet header also each penetrate an outer wall of the transmission pan and are each fixed to and sealed where the penetrations of the inlet header and the outlet header contact the outer wall.

In yet another example of the transmission pan with integrated heat exchanger for a motor vehicle of the present disclosure, the cooling header assembly further includes: an inlet nipple connected to the inlet header; and an outlet nipple connected to the outlet header; wherein the inlet nipple and the outlet nipple are each adapted to receive a hose providing for flow of a liquid coolant.

In yet another example of the transmission pan with integrated heat exchanger for a motor vehicle of the present disclosure, each of the inlet header and the outlet header are connected to a common side wall of the heat exchanger.

In yet another example of the transmission pan with integrated heat exchanger for a motor vehicle of the present disclosure, the inlet header and the outlet header are connected to different side walls of the heat exchanger.

In yet another example of the transmission pan with integrated heat exchanger for a motor vehicle of the present disclosure, the heat exchanger further includes a cooling header assembly having an inlet header and an outlet header, each fixed to and sealed at an entrance through a different wall of the heat exchanger.

In yet another example of the transmission pan with integrated heat exchanger for a motor vehicle of the present disclosure further includes a bolting flange of the transmission pan correspondingly shaped and adapted to couple with a bolting flange of the automatic transmission; and a depth of the transmission pan is selected to provide space above the heat exchanger for connections to the heat exchanger within the transmission pan for transmission fluid inlet and discharge to and from the heat exchanger.

In yet another example of the transmission pan with integrated heat exchanger for a motor vehicle of the present disclosure, the assembly has the heat exchanger fixed to a bottom inner surface of the transmission pan.

In yet another example of the transmission pan with integrated heat exchanger for a motor vehicle of the present disclosure, the heat exchanger is a stacked plate heat exchanger.

Further features, advantages, and areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way. The components in the figures are not necessarily to scale, emphasis instead being placed upon illustrating the principles of the invention. Moreover, in the figures, like reference numerals designate corresponding parts throughout the views. In the drawings:

FIG. 1 is a bottom left partial cross-sectional perspective view of a transmission pan with integrated heat exchanger mounted to a vehicle automatic transmission according to several aspects of the present disclosure;

FIG. 2 is a top left perspective view of the transmission pan with integrated heat exchanger of FIG. 1;

FIG. 3 is a top plan view of the heat exchanger of FIG. 2;

FIG. 4 is a side elevational view of the heat exchanger of FIG. 2; and

FIG. 5 is a rear elevation view of the heat exchanger of FIG. 2.

### DETAILED DESCRIPTION

The following description is merely exemplary in nature and is not intended to limit the present disclosure, application, or uses.

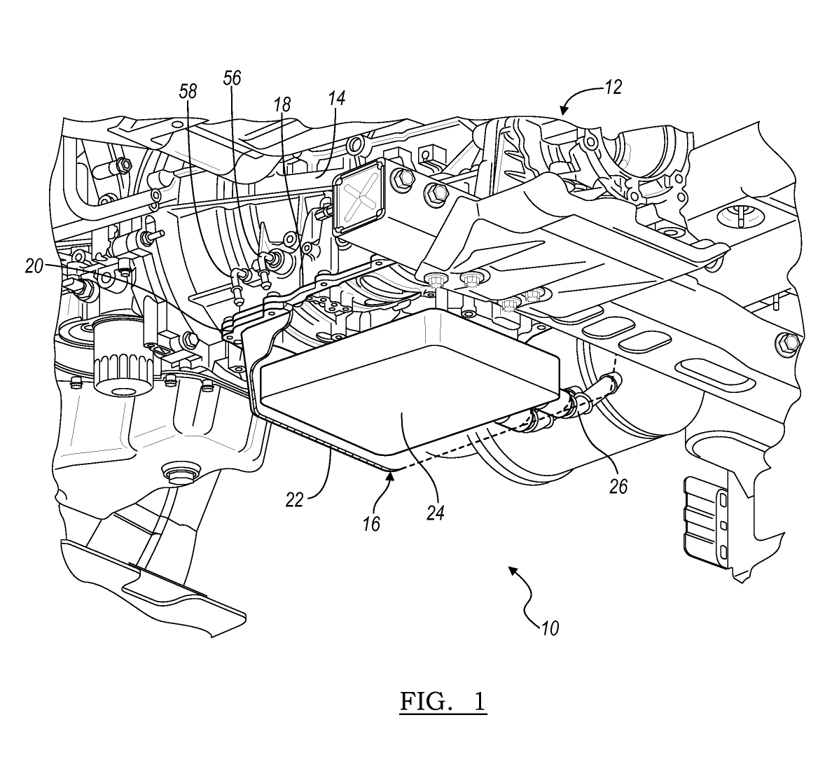

Referring now to the drawings, a transmission pan with integrated heat exchanger system 10 embodying the principles of the present invention is illustrated. With specific reference to FIG. 1, a transmission pan with integrated heat exchanger system 10 is provided with a motor vehicle 12, and is releasably connected, for example by fastening, to the sump area of an automatic transmission 14. An assembly 16 including a transmission pan and heat exchanger components is connected to the automatic transmission. A bolting flange 18 of the automatic transmission 14 is adapted to receive a correspondingly shaped bolting flange 20 of a transmission pan 22 of assembly 16. With a gasket in place to seal the transmission pan 22 to the bolting flange 18, internal space of the transmission pan 22 is substantially sealed from ambient conditions, and can be heated to transmission operating temperature, or cooled as necessary. Assembly 16 further includes a heat exchanger 24 and a cooling header assembly 26. According to several aspects, the heat exchanger 24 is positioned entirely within the internal space provided by the transmission pan 22, therefore with the gasket in place to seal the transmission pan 22 to the bolting flange 18 of the transmission 14, the heat exchanger 24 is substantially sealed from ambient conditions, protected by the walls of the transmission pan 22, and can be provided with a flow of transmission fluid and a source of cooling liquid, for example to heat the heat transmission fluid passed through the heat exchanger 24, or to cool the transmission fluid as necessary.

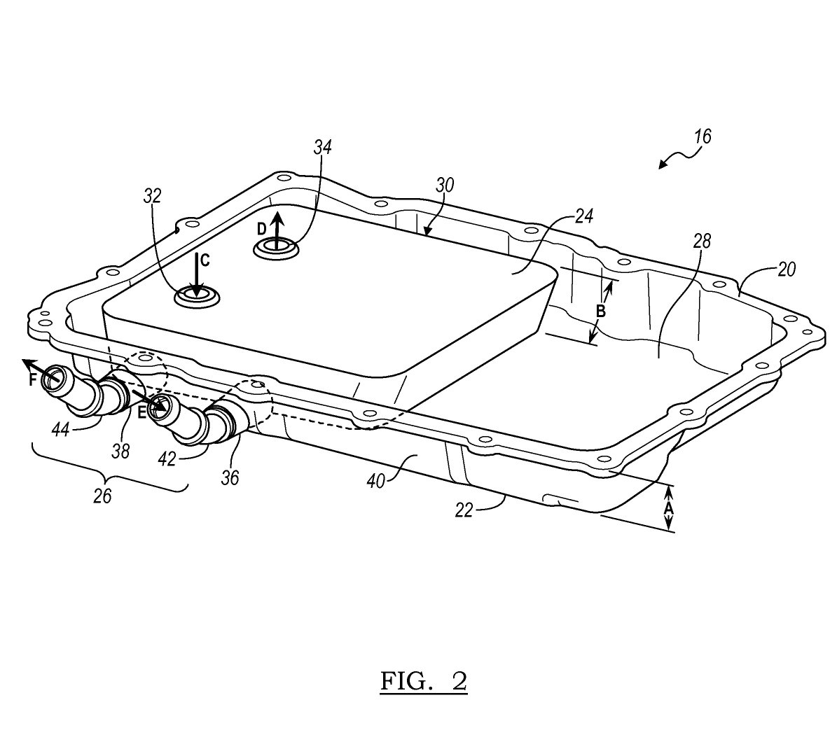

Referring to FIG. 2 and again to FIG. 1, the assembly 16 is shown prior to installation on the automatic transmission 14 for greater clarity. The heat exchanger 24, which according to several aspects is a stacked plate heat exchanger, is positioned in the pan cavity of transmission pan 22, and can be fixed to a bottom inner surface 28 of the transmission pan 22. Heat exchanger 24 can be of any desired geometry, however, a substantially flat surface 30, with a rectangular-shaped body as shown is one preferred embodiment to minimize a depth “A” of the transmission pan 22 required to incorporate a height “B” of the heat exchanger 24. According to several aspects, the surface 30 is an upward facing surface, therefore directly facing the automatic transmission 14 at the sump area of the transmission 14, thereby providing direct connection paths for piping or tubing that direct transmission fluid into or out of the heat exchanger 24. In other aspects, the heat exchanger 24 can be provided with the flat surface 30, but with a different perimeter body shape selected, such as round, oval, or a shape required to avoid interference with components of the transmission 14 in the sump area of the transmission.

The surface 30 of the heat exchanger 24 according to several aspects provides a first flow port 32 defining a transmission fluid inlet port, and a second flow port 34 defining a transmission fluid outlet port. For example, transmission fluid flows into the first flow port 32 of heat exchanger 24 in a flow direction “C” and exits second flow port 34 in a flow direction “D”. Connections provided in a sump area of the automatic transmission 14 are made during installation of the assembly 16 onto the automatic transmission 14 to direct transmission fluid that normally would collect at the bottom inner surface 28 instead into the first flow port 32 and out of the second flow port 34.

The cooling header assembly 26 includes an inlet header 36 and an outlet header 38, each fixed to and sealed at their entrances through a wall of the heat exchanger 24, for example by welding, brazing, or by a seal such as an O-ring. The inlet header 36 and the outlet header 38 also each penetrate an outer wall 40 of the transmission pan 22 and are each fixed to and sealed at the penetrations through the outer wall 40, for example by welding, brazing, or by a seal such as an O-ring. The inlet header 36 provides a total cooling water or fluid flow into the heat exchanger 24, where is it distributed through internal passageways (not shown) of the heat exchanger 24. The outlet header 38 collects the total cooling water or fluid flow from the internal passageways of the heat exchanger 24 (not shown), for return to the cooling water system of the motor vehicle.

An inlet nipple 42 is also connected to the inlet header 36, which is adapted to releasably receive a hose (not shown) providing a source of coolant liquid flow in an inlet cooling flow direction “E”. Similarly, an outlet nipple 44 is also connected to the outlet header 38, which is adapted to releasably receive a hose (not shown) providing for return flow of the liquid coolant in an outlet cooling flow direction “F”. Although the inlet nipple 42 and the outlet nipple 44 are shown in the exemplary aspect directed upwardly, the direction or orientation of the inlet nipple 42 and the outlet nipple 44 can be in any direction or orientation desired to suit the cooling supply and return system requirements or configuration.

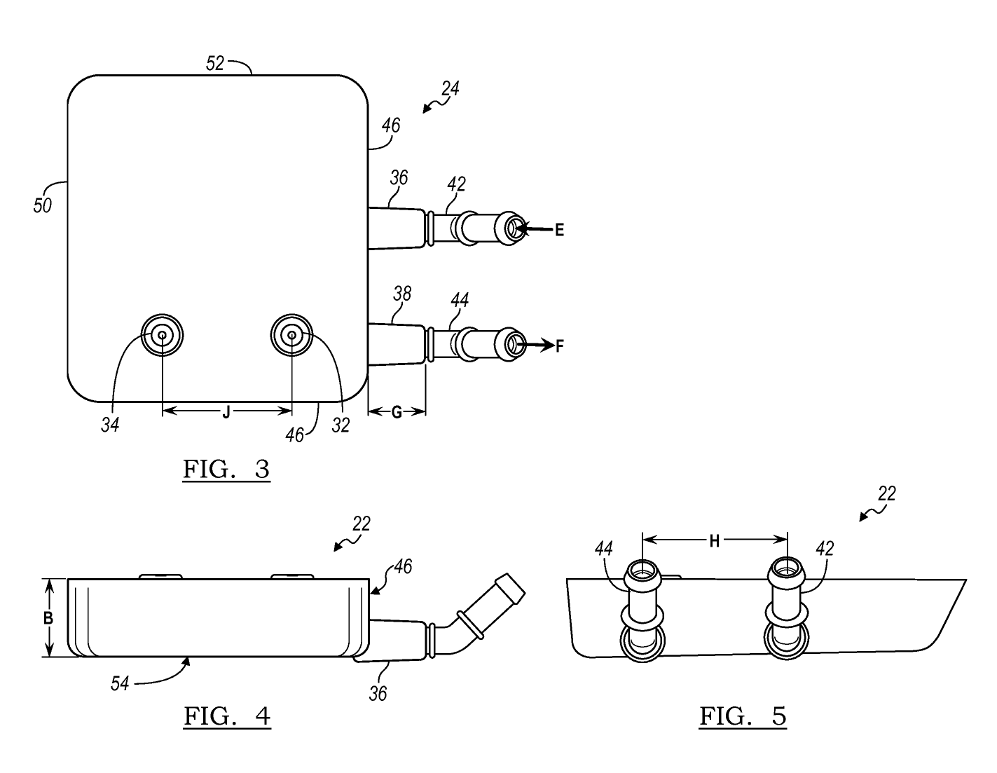

Referring to FIG. 3 and again to FIGS. 1-2, each of the inlet header 36 and the outlet header 38 can be connected to a common side wall of the heat exchanger 24, for example a first side wall 46. According to other aspects, the inlet header 36 and the outlet header 38 can also both be connected to any other side wall of the heat exchanger 24 such as a second, a third, or a fourth side wall 48, 50, 52. Both the inlet header 36 and the outlet header 38 may therefore penetrate any one of the side walls of the transmission pan 22. According to further aspects, the inlet header 36 and the outlet header 38 can also be separated from each other such that each is connected to a different one of the first, the second, the third, or the fourth side walls 46, 48, 50, 52. Each of the inlet header 36 and the outlet header 38 may therefore individually penetrate a different side wall of the transmission pan 22. A length “G” of the inlet header 36 and the outlet header 38 can also be varied to suit the internal geometry of the transmission pan 22 and the distance to the wall or walls of the transmission pan 22.

Referring to FIG. 4 and again to FIG. 3, an elevation of the inlet header 36 and the outlet header 38 at their exemplary connections with the first side wall 46 can be selected to encourage gravity induced internal drain of the cooling liquid out of the heat exchanger 24. As such, the elevation of the inlet header 36 and the outlet header 38 can be positioned approximately even with a heat exchanger bottom wall 54. According to further aspects, the inlet header 36 and the outlet header 38 can also be positioned at any desired height along height “B” of the heat exchanger 24.

Referring to FIG. 5 and again to FIG. 3, a spacing “H” between the inlet header 36 and the outlet header 38 can be selected to suit the desired arrangement of the cooling supply and return piping or tubing to the heat exchanger 24. Similarly, as shown in FIG. 3, a spacing “J” between the first flow port 32 and the second flow port 34 can also be selected to suit a spacing and/or geometry of the transmission components in the area of the sump of the transmission 14.

With reference again to FIGS. 1-3, the transmission 14 may include external transmission fluid ports 56, 58 already adapted for external discharge and return of a transmission fluid. The locations of the first flow port 32 and the second flow port 34 can therefore also be selected to allow use of the existing transmission fluid ports 56, 58 for inlet and outlet flow of transmission fluid to and from the heat exchanger 24 positioned within the transmission pan 22 by external flow lines (not shown) extending through one of the side walls of the transmission pan 22 and into the heat exchanger 24. Although this option provides some exposure of the transmission fluid to ambient temperature, the connection lines are short, and the heat exchanger 24 is still positioned entirely within the volume of the transmission pan 22, mitigating against ambient exposure of the heat exchanger 24.

Positioning the heat exchanger 24 entirely within the transmission pan 22 provides several advantages. The transmission pan 22 is designed to protect against environmental conditions and impact, therefore the heat exchanger 24 is protected against damage from environmental elements such as road debris and contaminants which can degrade heat exchanger performance. The environment within the transmission pan 22 is temperature moderated compared to mounting the heat exchanger 24 external to the transmission pan 22. This reduces thermal losses of the heat exchanger particularly during the period of engine and transmission startup and warmup and during operation in winter when environmental temperature may be lowest. The design of the transmission pan with integrated heat exchanger system 10 of the present disclosure also minimizes tubing and/or connections required to provide transmission fluid flow to and from the heat exchanger 24, which reduces costs, mitigates against transmission fluid leakage, and reduces maintenance associated with these components.

The description of the invention is merely exemplary in nature and variations that do not depart from the gist of the invention are intended to be within the scope of the invention. Such variations are not to be regarded as a departure from the spirit and scope of the invention.

What is claimed is:

1. A transmission pan with integrated heat exchanger for an automobile vehicle, comprising:
an assembly including:
a transmission pan; and
a heat exchanger positioned entirely within the transmission pan.

2. The transmission pan with integrated heat exchanger for an automobile of claim 1, wherein the heat exchanger includes a substantially flat surface, and a rectangular shaped body adapted to minimize a depth “A” of the transmission pan required to incorporate a height “B” of the heat exchanger.

3. The transmission pan with integrated heat exchanger for an automobile of claim 2, wherein the surface includes a first flow port defining a transmission fluid inlet port, and a second flow port defining a transmission fluid outlet port.

4. The transmission pan with integrated heat exchanger for an automobile of claim 1, wherein the heat exchanger further includes a cooling header assembly having:
an inlet header and an outlet header, each fixed to and sealed at an entrance through a wall of the heat exchanger; and
the inlet header and the outlet header also each penetrate an outer wall of the transmission pan and are each fixed to and sealed where the penetrations of the inlet header and the outlet header contact the outer wall.

5. The transmission pan with integrated heat exchanger for an automobile of claim 4, wherein the cooling header assembly further includes:
an inlet nipple connected to the inlet header; and
an outlet nipple connected to the outlet header;
wherein the inlet nipple and the outlet nipple are each adapted to receive a hose providing for flow of a liquid coolant.

6. The transmission pan with integrated heat exchanger for an automobile of claim 4, wherein each of the inlet header and the outlet header are connected to a common side wall of the heat exchanger.

7. The transmission pan with integrated heat exchanger for an automobile of claim 4, wherein the inlet header and the outlet header are connected to different side walls of the heat exchanger.

8. The transmission pan with integrated heat exchanger for an automobile of claim 1, wherein the heat exchanger further includes a cooling header assembly having an inlet header and an outlet header, each fixed to and sealed at an entrance through a different wall of the heat exchanger.

9. The transmission pan with integrated heat exchanger for an automobile of claim 1, further including:
a bolting flange of the transmission pan correspondingly shaped and adapted to couple with a bolting flange of the automatic transmission; and
a depth of the transmission pan selected to provide space above the heat exchanger for connections to the heat exchanger within the transmission pan for transmission fluid inlet and discharge to and from the heat exchanger.

10. The transmission pan with integrated heat exchanger for an automobile of claim 1, wherein the assembly has the heat exchanger fixed to a bottom inner surface of the transmission pan.

11. The transmission pan with integrated heat exchanger for an automobile of claim 1, wherein the heat exchanger is a stacked plate heat exchanger.

12. A transmission pan with integrated heat exchanger for an automobile vehicle, comprising:
an assembly including:
a transmission pan; and
a heat exchanger positioned entirely within the transmission pan,
the heat exchanger including a substantially flat surface, the surface including a first flow port defining a transmission fluid inlet port, and a second flow port defining a transmission fluid outlet port.

13. The transmission pan with integrated heat exchanger for an automobile of claim 12, wherein the heat exchanger further includes a cooling header assembly having an inlet header and an outlet header, each fixed to and sealed at an entrance through a wall of the heat exchanger.

14. The transmission pan with integrated heat exchanger for an automobile of claim 13, wherein the inlet header and the outlet header also each penetrate an outer wall of the transmission pan and are each fixed to and sealed where the penetrations of the inlet header and the outlet header contact the outer wall.

15. The transmission pan with integrated heat exchanger for an automobile of claim 13, wherein the cooling header assembly further includes an inlet nipple connected to the inlet header; and an outlet nipple connected to the outlet header.

16. The transmission pan with integrated heat exchanger for an automobile of claim 15, wherein the inlet nipple and the outlet nipple are each adapted to receive a hose providing for flow of a liquid coolant.

17. The transmission pan with integrated heat exchanger for an automobile of claim 12, wherein the surface is an upward facing surface therefore directly facing the automatic transmission at a sump area of the transmission, thereby providing direct connection paths for piping or tubing directing transmission fluid into or out of the heat exchanger.

18. A transmission pan with integrated heat exchanger for a transmission of an motor vehicle, comprising:
a transmission pan;
a heat exchanger positioned entirely within transmission pan and fixed to a bottom inner surface of the transmission pan, the heat exchanger including a substantially flat surface facing the transmission, the surface including a first flow port defining a transmission fluid inlet port, and a second flow port defining a transmission fluid outlet port; and
a cooling header assembly having an inlet header and an outlet header, each fixed to and sealed at an entrance through a wall of the heat exchanger, the inlet header and the outlet header also each penetrating an outer wall of the transmission pan and are each fixed to and sealed where the penetrations of the inlet header and the outlet header contact the outer wall.

19. The transmission pan with integrated heat exchanger for a motor vehicle of claim 18, wherein the cooling header assembly further includes:
an inlet nipple connected to the inlet header; and
an outlet nipple connected to the outlet header.

20. The transmission pan with integrated heat exchanger for an automobile of claim 18, wherein the wherein the inlet nipple and the outlet nipple are each positioned outside of the transmission pan and are adapted to receive a hose providing for flow of a liquid coolant.
